(19) United States
(12) Patent Application Publication
(10) Pub. No.: US 2006/0209143 A1
(43) Pub. Date: Sep. 21, 2006

(54) Method and apparatus for recovering ink from inkjet cartridges

(76) Inventor: Stephen Morriss, Victoria (AU)

Correspondence Address: FISH & RICHARDSON P.C., P.O. BOX 1022, MINNEAPOLIS, MN, 55440-1022, US

(21) Appl. No.: 10/544,684

(22) PCT Filed: Feb. 6, 2004
(86) PCT No.: PCT/AU04/00134

§ 371 Date: Apr. 5, 2006

(30) Foreign Application Priority Data
Feb. 7, 2003 (AU) 2003900535

(51) Int. Cl. B41J 2/175

(52) U.S. Cl. 347/86

(57) ABSTRACT

The invention provides an apparatus and method for the recovery of ink from inkjet cartridges. The apparatus includes means (1) for breaking the ink cartridges into pieces, thereby releasing any ink and compressible material or sponge from within the otherwise substantially sealed cartridges; a washing stage (2) whereby ink is removed with solvent; and a draining stage (3) where excess solvent is drained from the cartridge pieces.

### TECHNICAL FIELD

The present invention relates generally to recycling of inkjet cartridges, and more particularly to the separation of materials during the recycling of inkjet cartridges.

### DESCRIPTION OF THE PRIOR ART

The invention has been developed primarily for use in recovering ink from inkjet cartridges, and will be described predominantly with reference to this application. It will be appreciated, however, that the invention is not limited to this particular field of use, being also applicable to other applications where separating a liquid material from containers is required.

Inkjet printing technology has been almost universally adopted in computer printers, particularly for domestic and smaller low volume printers. These devices commonly have a disposable ink cartridge for storing the ink used in the printing process. While in some instances the cartridges are refillable, for the most part they are filled in a factory and purchased as a disposable item.

The popularity of disposable cartridges along with the uptake of personal computers has meant the number of ink cartridges used and subsequently discarded has increased exponentially in recent years. Used cartridges may, in some cases, be recycled and recharged a number of times by a specialist reconditioner. Eventually however, all cartridges are either stripped down for their materials or more often, thrown out altogether. Either of these alternatives presents their own particular problems.

The cartridges are generally a combination of thermo-plastic resins and ferrous and non-ferrous metals. Often, the cartridges also include a porous compressible material such as a sponge within the ink reservoir. These materials are slow to break down naturally and thus present a significant environmental pollutant. In addition, it is rare that ink cartridges are entirely empty when they are replaced. The sponge tends to soak up a proportion of the ink and often 5% to 10% of the ink capacity of the cartridge remains within the cartridge when it is discarded. This figure may be as high as 100% if the cartridge has not been used because it is faulty, has been superseded or past its use by date. The residual ink also presents a significant environmental hazard when the cartridges are thrown out. However, whilst the ink along with the materials which make up the cartridges are both recyclable, the collection and separation of the ink from the rest of the cartridge, and particularly the sponge, has proved difficult.

It is an object of the present invention to overcome or ameliorate one or more of these disadvantages of prior art, or at least to provide a useful alternative.

### BRIEF SUMMARY OF THE INVENTION

In a first aspect, the invention provides method of recovering ink from inkjet cartridges, said method including the steps of:

breaking up ink cartridges into pieces to release any ink within the cartridges;

applying a solvent compatible with the ink to the cartridge pieces; and

drying the cartridge pieces to substantially separate cartridge pieces from ink and solvent.

Preferably, an agitating means is used to aid washing of the cartridge pieces with said solvent.

Preferably, the solvent is applied nozzle to the cartridge pieces by at least one spray nozzle.

Alternatively, the solvent is applied by immersing the cartridge pieces in a solvent bath wherein, first and second screw conveyors to transport the cartridge pieces into the bath, under the surface of the solvent and then subsequently from the bath.

Preferably, the first and second conveyors intersect below the surface of the solvent an angle of about 110°.

Preferably, the apparatus includes a centrifugal separator to substantially dry the cartridge pieces and a conduit system to collect fluid separated from the cartridge pieces.

Preferably, the ink is water based and the solvent is substantially water. According to a second aspect, the invention provides an apparatus for recovering ink from inkjet cartridges including:

a shredder to break up the inkjet cartridges into pieces and release any ink within the cartridges;

solvent application means to apply the cartridge pieces with a solvent compatible with the ink to promote release of the ink from the pieces; and

a separator to substantially separate the cartridge pieces from the ink and solvent.

In processing cartridges that are full or contain a substantial amount of ink, it may be possible and expedient to dispense with the use of a solvent altogether. In such cases, the increased volume of ink tends to provide adequate flow of ink without the need to wash it from the cartridge pieces. In such cases the cartridges are shredded to release the ink and then placed in the separator to substantially separate the ink.

### BRIEF DESCRIPTION OF THE DRAWINGS

A preferred embodiment of the invention will now be described, by way of example only, with reference to the accompanying drawings in which:

FIG. 1 is a top view of an apparatus for recovering ink from inkjet cartridges in accordance with the invention;

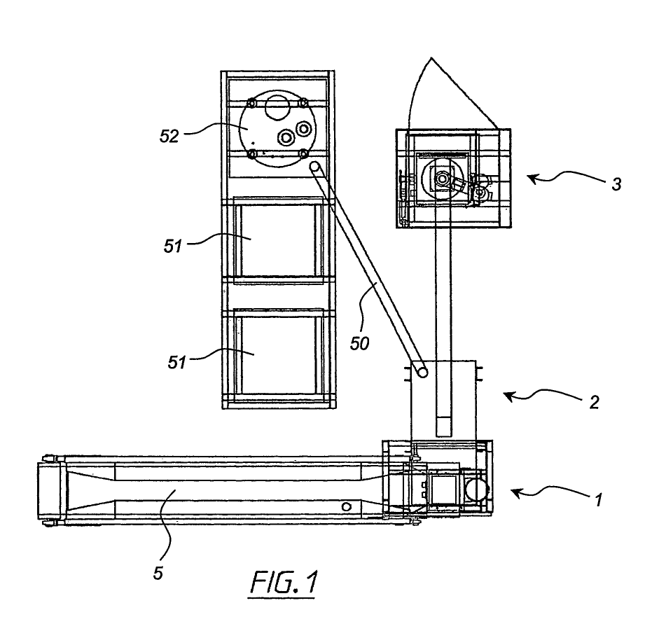

FIG. 2 is left side view of the apparatus shown in FIG. 1;

FIG. 3 is a front view of the apparatus shown in FIG. 1;

FIG. 4 is an enlarged front view of the apparatus shown in FIG. 3; and

FIG. 5 is a right side view apparatus shown in FIG. 1.

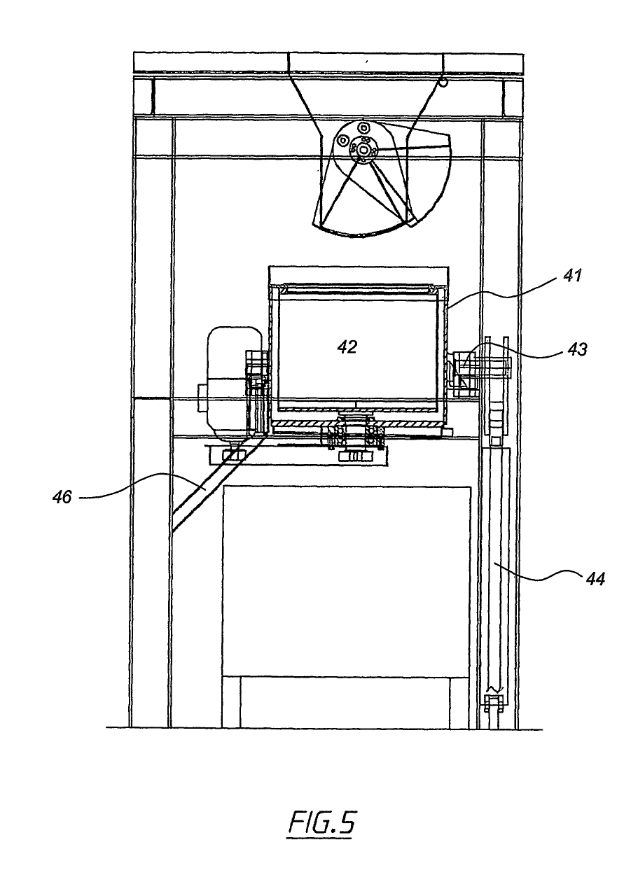

### DETAILED DESCRIPTION OF THE INVENTION

Referring to the drawings, in general terms the invention provides an apparatus and method for the recovery of ink from inkjet cartridges. The apparatus includes means 1 for breaking the ink cartridges into pieces, thereby releasing any ink and compressible material or sponge from within the otherwise substantially sealed cartridges; an ink removing stage 2 whereby ink is removed form the cartridge pieces; and a draining stage 3 where excess solvent is drained from the cartridge pieces.

To describe the invention in more detail, the ink jet cartridges are collected and transported to the plant for recycling. Before the cartridges are processed, they may be examined to determine statistical information on the origin, number and types of cartridges as well as a check to ensure that each cartridge is suitable for processing.

The examination may be conducted by a manual check of each cartridge or by automatic means. Automatic examination means may include a barcode and bar-code reader system, electronic data chip and reader or knowledge/image database recognition.

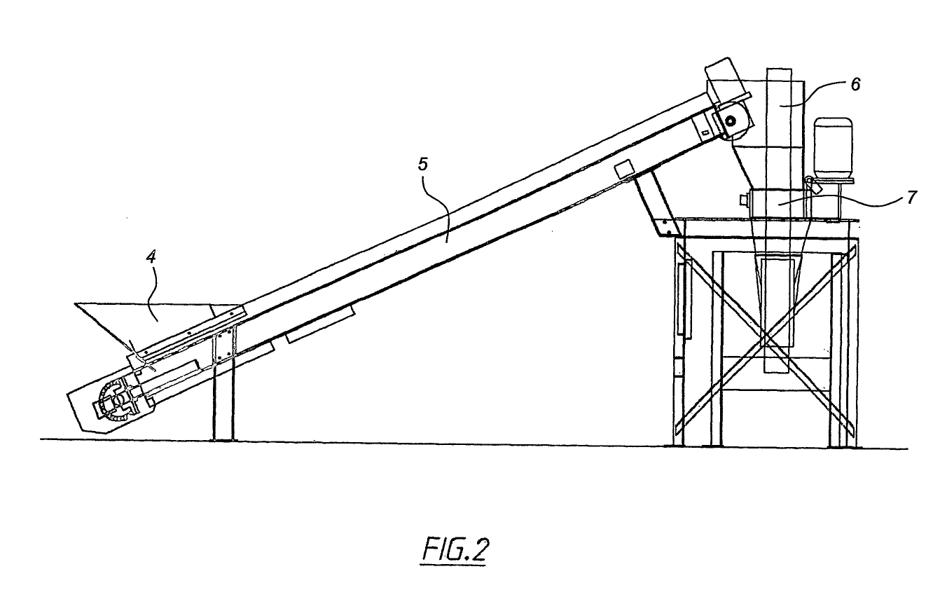

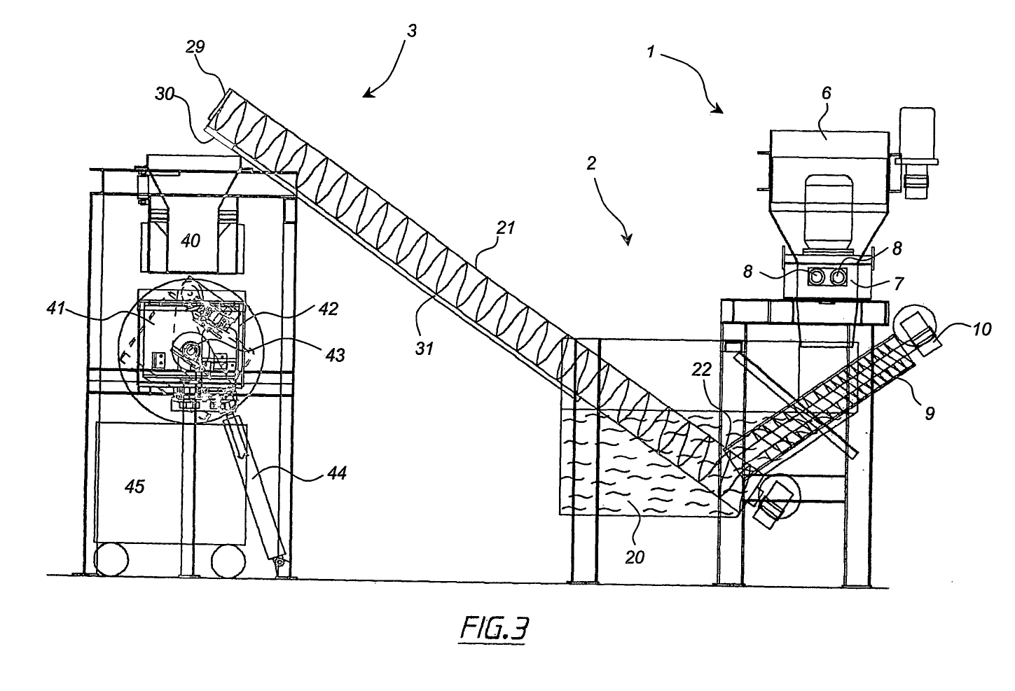

Referring to FIG. 2, the cartridges are then placed in a feed chute 4 which feeds a conveyor belt 5. The conveyor transports the whole cartridges to a shredder hopper 6 situated above the shredder 7. As best seen in FIG. 3, the shredder employs twin rollers 8 with intermeshing projections to grind the cartridges into pieces or at least breach the casing of the cartridge to release the ink within. Commonly, the shredder uses teeth of around 10 mm in size. The output of the shedder consists of some free ink released from within the cartridge and solids, including hard pieces of plastic casing and metal and larger pieces of foam or sponge. The foam is little affected by the shedder but the other solids are reduced to a size dictated by the shedder.

The cartridge pieces, including any compressible material and free ink drop down into a first enclosed screw conveyor 9. Driven by electric motor 10, the screw conveyor 9 carries the output from the shredder 7 into a bath 20 filled with solvent. The application of solvent from the bath helps mobilise the ink so it can be washed from the solid cartridge pieces.

It is important to note that the solvent must be compatible with the type of ink used in the cartridges. In this embodiment the ink is water based and accordingly water is used as a solvent. However, in other applications, for example, if the cartridges contain a petroleum based ink then a suitable petroleum based solvent should be used.

Furthermore, to achieve adequate application of the solvent and washing out of the ink, it is usually necessary to thoroughly mix the cartridge pieces with the solvent. Such mixing can be effectively achieved by submerging the shredded pieces and providing a degree of agitation between the pieces and the solvent.

A difficulty is that the shredder output contains pieces of plastics and foam that are buoyant in water as well as metal pieces that are not. In this regard, enclosed screw conveyors have been found to be an effective means of continuously transporting the ground pieces into and out of the bath as well as forcing them under the surface of the water and providing a degree of agitation. A casing around the conveyor prevents the pieces sinking to the bottom of the bath or floating away. To ensure that ink washed from the pieces disperses throughout the bath rather than becoming super concentrated in the conveyor, water is continuously drawn from the bath, outside the conveyor and pumped in to the conveyors to mix with the pieces. In addition, some of this water drawn from the bath is sprayed into the shedder to wash away ink residue.

In alternative embodiments the screw conveyors may be replaced with other forms of continuous or batch conveying systems and agitating systems.

From the first screw conveyor 9 the shredded material is pushed into a second enclosed screw conveyor 21 that carries the shredded material out of the bath 20. The screw conveyors are generally perpendicular to one another so that the junction 22 between the two screw conveyors 9 and 21, is submerged in the bath 20. This ensures that the shredded material is forced under the surface of the water in the tank. In addition, the transfer of the material from first to second conveyor provides an additional measure of agitation. The cartridge pieces are submerged in the tank for approximately 1 minute.

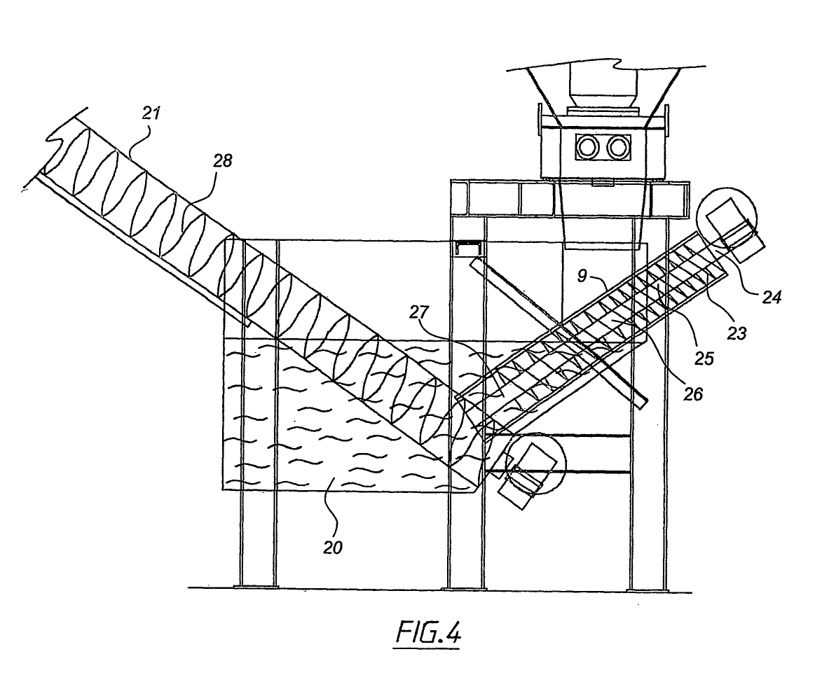

Another problem is that due to a combination of the compressible nature of the foam, the effect of the water, buoyancy of the material and junction between the conveyors, there is a tendency for the conveyors to become clogged. To overcome this problem, several modifications to the screw conveyors have been found to be beneficial when transporting the ground pieces into, through and out of the bath. Referring to FIG. 4, the screw 23 of the first screw conveyor 9 is attached to a drive shaft 24 and can be divided up into three sections. A top section 25 where the shredder pieces are introduced and the screw steps are at a constant pitch, a middle section 26 having variable pitched steps so that the distance between the steps increases nearer the bath and a end section 27 before the junction of the conveyors where the steps are removed and only the shaft 24 remains. This end section is around 400 mm long. Furthermore, an angle between the conveyors of between 90° to 130° has been found to enable transmission of the material between the conveyors. In this embodiment the angle between the conveyors is 110°.

In contrast to the first conveyor, the second screw conveyor 21 uses a constant pitch screw 28 having an open centre or no central shaft. It will be appreciated that the material, and in particular the sponge material, extracted from the bath by the second conveyor is “wet” with water and to a lesser degree ink. The open centre of the conveyor 21 allows this fluid to run off and drain back down the conveyor and into the bath. As shown in FIG. 3, to further enhance run off, an end plate 29 at the top of the conveyor may be used as a stop so that the material within the conveyor is partially compressed before it exits through an outlet 30 at the top of the conveyor 21, thus squeezing out some of the water. A passage 31 is provided to channel any fluid back into the bath.

The wet material exiting the second conveyor 21 drops down into a second hopper 40. This hopper is used to batch feed a centrifuge separator 41, as is known and used in the art, which separates most of the remaining fluid from the solid cartridge pieces. The separator typically has a capacity of 5 kg and run at a maximum spin speed of 1000 rpm. The separator drum 42 is mounted on a pivot 43 and may be tilted by an actuating means 44 to empty the drum into a barrow 45. In FIG. 3 the drum is shown in solid line is in the upright position for loading and operation and in ghost line, in the tilted position for unloading. Liquid extracted from the solid material by the separator is pumped back into the bath through conduits (not shown). The solid material may then be further refined by other separation processes.

In further embodiments, the ink may be extracted without submerging the cartridge pieces but rather applying the solvent by spraying solvent on to the cartridge pieces. This may occur after shredding as the pieces are moved from the shredder to the separator 41 or when they are in the separator, before or selectively during separator operation. It is advantageous for the spray to provide full wetting of the pieces to adequately mobilise and wash out the ink. Improved wetting may be achieved by either spraying the pieces from a plurality of sides and/or agitating the pieces during the spraying process. Agitation may be provided by shaking, vibrating or turning of the pieces as they are moved from the shredder to the separator.

In still further embodiments, which may be particularly applied when processing cartridges that are full or contain a substantial amount of ink, the cartridge pieces are placed into the separator without the application of solvent. The liquid ink is extracted only by centrifugal forces exerted due to the high rpm spinning of the separator drum. The larger volume of ink in the cartridges may not require solvent to facilitate the separation of the ink from the cartridge pieces meaning that it is not necessary to distil or separate the ink from the solvent.

The plant also includes a filtering system. Fluid taken from the separator and the top of the second conveyor is filtered before it returns to the tank. In addition, the fluid continuously drawn from the bath and pumped into the conveyors and shredder is also filtered.

The following is a description of one method of operating the plant. The exact volumes may change from those recited in this preferred embodiment. The bath is filled with water to a lower level of 660 litres. Under normal operation, the volume of fluid in the bath will gradually increase as ink is extracted from the cartridges and added to the bath. When the level in bath increases to an upper level, in this case 800 litres, the difference between the upper and lower levels (140 litres of fluid) is extracted from the tank. This fluid is filtered before being pumped through conduits 50 into a storage tank 51. The plant continues to run until the level again reaches the upper level and the process is repeated.

It will be apparent that by operating the plant in this manner, the concentration of ink in the water will gradually increase. When the concentration reaches a predetermined value, the entire contents of the bath is filtered and pumped into the storage tank 51. The fluid collected in the storage tank is then run through a suitable evaporator distillation plant 52 to separate the ink from the water. The ink is extracted and removed and the water may be returned to the bath and reused in the separation process.

In the cases where a bath is not used, the solvent may be collected from a collection tray under the spay nozzles and processed in much the same manner as the ink from the bath.

It will be appreciated that the invention provides a largely automated method and apparatus for recovering ink powder from ink jet cartridges. The invention enables the materials of cartridges to be recycled quickly, in a cost effective manner. Moreover, because the water used in the plant is also recycled, the process has a minimum negative impact on the environment. In all these respects, the invention represents practical and commercially significant improvement over the prior art.

Although the invention has been described with reference to specific examples it will be appreciated by those skilled in the art that the invention may be embodied in many other forms.

1. An apparatus for recovering ink from inkjet cartridges including comprising:
a shredder adapted to break up the inkjet cartridges into pieces and release any ink within the cartridges;
a solvent applicator adapted to apply the cartridge pieces with a solvent compatible with the ink to promote release of the ink from the pieces; and
a separator adapted to substantially separate the cartridge pieces from the ink and solvent.

2. An apparatus according to claim 1 further comprising an agitating means adapted to aid in the application of the cartridge pieces with said solvent.

3. An apparatus according to claim 1 wherein the solvent applicator comprises at least one spray nozzle adapted to apply the solvent to said cartridge pieces.

4. An apparatus according to claim 1 wherein the solvent applicator comprises a bath of said solvent to immerse the cartridge pieces.

5. An apparatus according to claim 4 further comprising a first screw conveyor adapted to transport the cartridge pieces into the bath and under the surface of the solvent.

6. An apparatus according to claim 4 further comprising a screw conveyor adapted to transport the cartridge pieces from the bath.

7. An apparatus according the claim 5 further comprising a second screw conveyor adapted to transport the cartridge pieces from the bath; and
wherein the first and second conveyors intersect at an angle of between about 90° and about 130°.

8. An apparatus according to claim 7 wherein the first and second conveyors intersect at an angle of about 110°.

9. An apparatus according to claim 5 wherein the first conveyor includes a screw having a generally decreasing pitch with proximity to the bath.

10. An apparatus according to claim 6 wherein the conveyor has a screw of constant pitch and an open centre.

11. An apparatus according to claim 1 further comprising a centrifugal separator adapted to substantially dry the cartridge pieces.

12. An apparatus according to claim 11 further comprising a conduit system adapted to collect fluid separated from the cartridge pieces.

13. An apparatus according to claim 11 wherein the ink is water based and the solvent is substantially water.

14. A method of recovering ink from inkjet cartridges, said method comprising:
breaking up inkjet cartridges into pieces to release any ink within the cartridges;
applying a solvent compatible with the ink to the cartridge pieces; and
drying the cartridge pieces to substantially separate cartridge pieces from ink and solvent.

15. A method according to claim 14 wherein the cartridge pieces are agitated to aid application of said solvent.

16. A method according to claim 14 wherein a shredder is used to break up the cartridge pieces.

17. A method according to claim 14 wherein the solvent is applied by spraying the cartridge pieces with said solvent.

18. A method according to claim 14 wherein the solvent is applied by immersing the cartridge pieces in a solvent bath.

19. A method according to claim 18 wherein the cartridge pieces are transported into the bath and under the surface of the solvent by a first screw conveyor.

20. A method according to claim 18 wherein the cartridge pieces are transported from the bath by a screw conveyor.

21. A method according to claim 19 wherein the cartridge pieces are transported from the bath by a second screw conveyor and the first and second conveyors intersect at an angle of between about 90° and about 130°.

22. A method according to claim 21 wherein the first and second conveyors intersect at an angle of about 110°.

23. A method according to claim 19 wherein the first conveyor includes a screw having a generally decreasing pitch with proximity to the bath.

24. A method according to claim 14 wherein the cartridge pieces are substantially dried in a centrifugal separator.

25. A method according to claim 14 wherein the ink is water based and the solvent is substantially water.
